(19) United States
(12) Patent Application Publication
(10) Pub. No.: US 2024/0217687 A1
(43) Pub. Date: Jul. 4, 2024

(54) MUSHROOM PACKING APPARATUS

(71) Applicant: CONFIRMED AUTOMATION SYSTEMS INC., Kamloops (CA)

(72) Inventors: John Michael Gardiner, North Vancouver (CA); Jarred Alexander Positano, North Vancouver (CA); Bayden William Hamilton, North Vancouver (CA); José de Jesús Loza Alcalá, North Vancouver (CA); John Kyle Gardiner, North Vancouver (CA); Laura Kimberlin Gardiner, Toronto (CA)

(21) Appl. No.: 18/576,897

(22) PCT Filed: Jul. 22, 2021
(86) PCT No.: PCT/CA2021/051023

§ 371 Date: Jan. 5, 2024

(51) Int. Cl. B65B 25/04; A01G 18/70; A23N 15/04; B65B 5/06; B65B 35/24; B65B 57/10; B65B 63/00

(52) U.S. Cl. CPC B65B 25/04; A23N 15/045; B65B 5/068; B65B 35/24; B65B 57/10; B65B 63/00; A01G 18/70

(57) ABSTRACT

A mushroom packing apparatus (10) comprises a conveyor (12) having a mushroom loading section (30) and an unloading end (42) for unloading the mushrooms into a container (16); a mushroom stem cutter (56): a movable support platform (14) for the container adjacent to the unloading end with weighing means (66) for determining the weight of the loaded mushrooms; the unloading end (42) being movable into a plurality of positions relative to the container; the movable support platform being movable such that a plurality of locations in the container are moved into a position proximate to the unloading end. The apparatus results in increased picking speed. It can load each till or box to the target weight, and fill tills when they are in lugs, so workers do not need to handle individual filled tills.

### FIELD OF THE INVENTION

The invention pertains to the harvesting and packaging of mushrooms, and in particular to an apparatus for packing mushrooms into containers.

### BACKGROUND OF THE INVENTION

Commercial mushroom harvesting is typically a labour-intensive manual operation. Finding sufficient workers is a problem in the industry.

In commercial growing operations, grow beds are usually six to eight shelves high, and pickers use various devices to access the different levels. These are typically similar to a scissor lift that moves up and down and travels horizontally on wheels. Such devices are generically referred to as “picking lorries” or “harvest platforms.”

The current manual picking and packing process involves a picker using one hand to pick the mushroom from the grow bed and cutting the mushroom stem with a knife held in the other hand, to remove compost. The stem is placed in a waste bucket on the picking lorry, and the cut mushroom is placed into a package—either a box or a till (also called a “punnet”). Where tills are the final product, they are typically placed in a plastic container referred to in the industry as a “lug” (or a “nestier” or “case”). Mushroom growers provide lugs with the empty tills placed in the lug for the picking worker to fill.

The next step is confirmation of the till or box weight. For example, an 8 ounce till should have very close to 8 ounces of mushrooms. This step is typically handled in the packing room of a commercial growing operation, where workers with manual scales check and adjust the number of mushrooms in each package to bring it as close as possible to the target weight. Manual adjustment of the till or box weight is a labour intensive step.

Efforts have been made to develop equipment to increase the rate at which mushroom picking workers can pick and pack mushrooms, in order to reduce the number of workers required. Such equipment includes robots and conveyor systems. In some cases these require extensive capital for purchase (for example, 3D vision guided robots) and significant infrastructure changes at the growing buildings. These infrastructure changes can include purchase of new grow beds, or even a requirement to build a new growing building to accommodate the equipment. There is no one solution that has been generally accepted in the industry.

One type of equipment that has been developed is conveyors with holes in the belt installed along the length of the grow bed. The conveyor raises and lowers on cables depending on which bed elevation the picking worker is harvesting. Cutting blades at the end of the conveyor are used to cut the stems to remove compost. At present, picking rates have not increased significantly using this type of equipment because the infrastructure required at the end of the conveyor to pack the tills has not advanced sufficiently. This type of equipment also has significant infrastructure expense and will often not fit in existing growing rooms.

WO 2020/156753 (Edwards) discloses an apparatus having a finger conveyor and using suction cups to pick up mushrooms and drop them into tills, one till at a time. The apparatus fills the tills automatically, but workers still need to take each till and place it in a lug, which slows down the picking. Suction cups need an air system, which is not typically present in existing growing houses. The apparatus also requires a custom rail system to be mounted to the sides of the grow beds.

US 2004/0099467 (Doake) discloses a mushroom packing apparatus having a grading conveyor which extends along the length of the growing bed. Tills are weighed but not in lugs. The apparatus replaces each container that has reached a predetermined weight by an empty one.

Other examples of equipment developed for use with mushroom harvesting are disclosed in U.S. Pat. No. 3,734,004 (Losito), U.S. Pat. No. 4,198,903 (Turatti), and U.S. Pat. No. 5,234,375 (Hendricks).

There remains a need for effective apparatus for packing mushrooms which ameliorates some of the disadvantages of existing systems.

### SUMMARY OF THE INVENTION

One aspect of the invention provides a mushroom packing apparatus, comprising: (a) a conveyor having a mushroom loading section for receiving mushrooms onto the conveyor and an unloading end for unloading the mushrooms from the conveyor; (b) a movable support platform adjacent to the unloading end of the conveyor for supporting a container holding a plurality of mushroom tills, the tills being arranged in a plurality of rows with each said row extending along a length of the container and having a plurality of the tills; (c) the movable support platform having weighing means for determining the weight of the mushrooms loaded into each of the tills in the container; (d) the unloading end of the conveyor being movable between positions proximate to each of the rows of tills in the container, for unloading of the mushrooms into the tills in each of the rows; (e) the movable support platform being movable such that each of the tills in a respective one of said rows in the container is moved into a position proximate to the unloading end of the conveyor, for unloading of the mushrooms into each of the tills within said respective row; (f) means for cutting stems from the mushrooms being conveyed on the conveyor; and (g) control means for controlling operation of the apparatus.

Another aspect of the invention provides a mushroom packing apparatus, comprising: (a) a conveyor having a mushroom loading section for receiving mushrooms onto the conveyor and an unloading end for unloading the mushrooms from the conveyor; (b) a movable support platform adjacent to the unloading end of the conveyor for supporting a container, the container having a length generally parallel to a longitudinal axis of the packing apparatus and a width perpendicular to said length; (c) the movable support platform having weighing means for determining the weight of the mushrooms loaded into the container; (d) the unloading end of the conveyor being movable into a plurality of positions proximate to respective locations across the width of the container, for unloading the mushrooms into said locations across the width of the container; (e) the movable support platform being movable such that a plurality of locations along the length of the container are moved into a position proximate to the unloading end of the conveyor, for unloading the mushrooms into the container at said plurality of locations along its length; (f) means for cutting stems from the mushrooms being conveyed on the conveyor; and (g) control means for controlling operation of the apparatus.

Another aspect of the invention provides a mushroom packing apparatus, comprising: (a) a conveyor having a mushroom loading section for receiving mushrooms onto the conveyor and an unloading end for unloading the mushrooms from the conveyor into a container; (b) a movable support platform adjacent to the unloading end of the conveyor for supporting the container; (c) the movable support platform having weighing means for determining the weight of the mushrooms loaded into the container; (d) the unloading end of the conveyor being movable into a plurality of positions relative to the container, for unloading the mushrooms into a plurality of locations in the container; (e) the movable support platform being movable such that a plurality of locations in the container are movable into a position proximate to the unloading end of the conveyor, for unloading the mushrooms into a plurality of locations in the container; and (f) control means for controlling operation of the apparatus.

A further aspect of the invention provides a method of packing mushrooms into a plurality of tills held in a container, comprising the steps of: (a) placing the mushrooms onto a loading section of a conveyor; (b) cutting the stems of the mushrooms on the conveyor; (c) moving the mushrooms on the conveyor to an unloading end of the conveyor; (d) dropping the mushrooms from the unloading end of the conveyor into the tills, the tills being arranged in a plurality of rows across the width of the container, with each row having a plurality of tills along the length of the container, the container being supported on a movable support platform; (e) moving the unloading end of the conveyor into positions proximate to each of the rows of tills in the container, for unloading of the mushrooms into the tills in each of the rows; and (f) moving the support platform to move each of the tills in each row into a position proximate to the unloading end of the conveyor, for unloading of the mushrooms into each of the tills with the respective row.

The invention has important advantages. The mushroom packing apparatus can be fitted on existing picking lorries or wheeled carts with little or no modification to the lorry or cart. It does not require infrastructure changes to the growing house. It results in increased picking speed. The apparatus can load each till or box to the target weight with no need for weight adjustment in the packing room, resulting in labour savings there. Importantly, the apparatus can fill the tills when they are in the lugs, so workers do not need to handle individual filled tills. This is particularly useful because it is a global industry standard to pack mushrooms in tills placed in lugs.

Further aspects of the invention and features of specific embodiments of the invention are described below.

### BRIEF DESCRIPTION OF THE DRAWINGS

The accompanying drawings illustrate non-limiting example embodiments of the invention.

FIG. 1 is a perspective view of a mushroom packing apparatus according to one embodiment of the invention, viewed from the operator's side of the apparatus.

FIG. 2 is a further perspective view of the apparatus.

FIG. 3 is an elevational view of the apparatus, from the longitudinal side opposite to the operator's side.

FIG. 4 is an elevational view of the apparatus from the operator's side.

FIG. 5 is a perspective view of the apparatus, in position to be attached to a picking lorry.

FIG. 6A is a top plan view of the apparatus, with the unloading end of the conveyor proximate to a first row of tills in a container.

FIG. 6B is a top plan view of the apparatus, with the unloading end of the conveyor proximate to a third row of tills in a container.

FIG. 7 is a perspective view of a detail of the apparatus, showing the unloading end of the conveyor, the stem cutter and discharge chute.

FIGS. 8A and 8B are elevation views of a detail of the apparatus, showing the support platform in the raised and lowered positions, respectively.

FIGS. 9A and 9B are elevation views of a detail of the apparatus, showing the conveyor belt assembly in a higher and lower position, respectively, for stem cutting.

FIGS. 10A and 10B are elevation and top plan views respectively of a detail of the apparatus, showing the mushroom slicer.

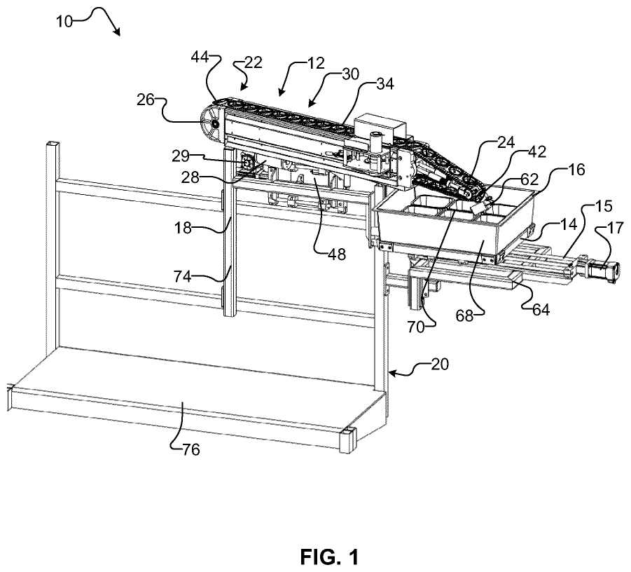

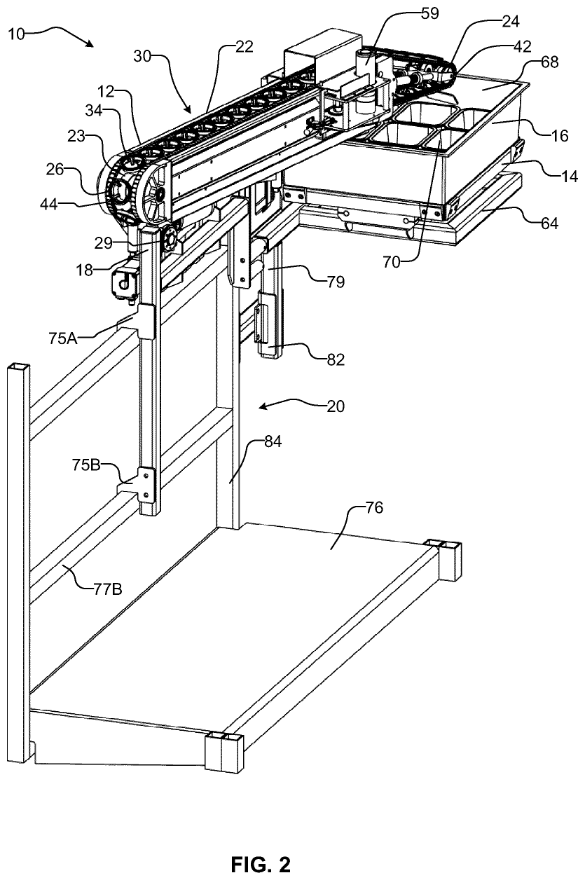

### DETAILED DESCRIPTION

The mushroom packing apparatus 10 has a conveyor 12, a support platform 14 for holding a container 16 into which mushroom are loaded from the conveyor, and a frame 18 which is attached to a picking lorry 20.

The conveyor 12 has a conveyor belt assembly 22 which travels over two end rollers 24, 26. A motor 28 and gearbox 29 are operatively connected to rotate one end roller 26 and thus drive the conveyor belt assembly. The conveyor belt assembly 22 comprises two spaced-apart chains 23 affixed to and separated by a plurality of cups 34 for holding the mushrooms 32. The conveyor 12 has a generally horizontal section 30 for loading the mushrooms into the cups 34. The mushrooms are manually placed into the cups in such a manner that the stems 36 of the mushrooms extend downward through holes 38 in the cups and the caps 40 of the mushrooms are held upwards in the cups.

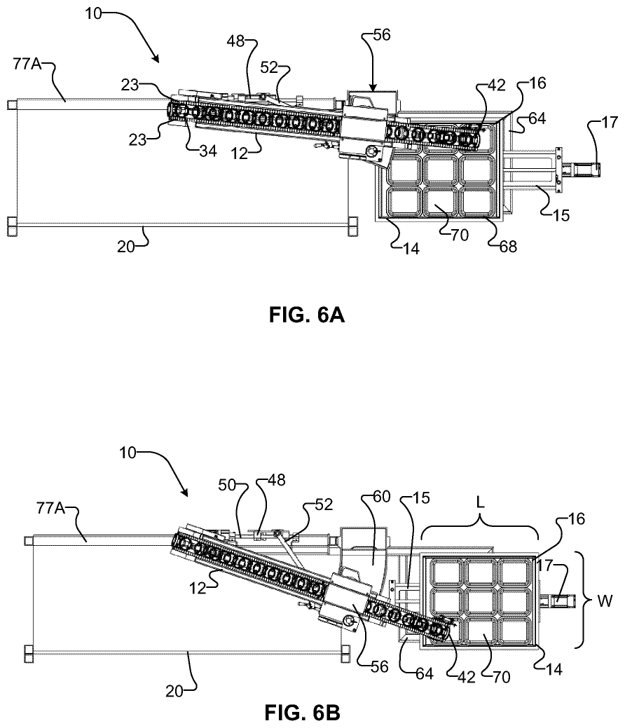

The conveyor 12 is mounted on the frame 18 to swivel about its loading end 44 in such a manner that its unloading end 42 is movable across the width W of the container 16, as best seen in FIGS. 6A and 6B. This lateral movement brings the unloading end into proximity with all positions across the width of the container in order that the mushrooms can be dropped into different positions in the container, as explained below. The end roller 24 at the unloading end 42 of the conveyor is supported by a belt tensioner 45.

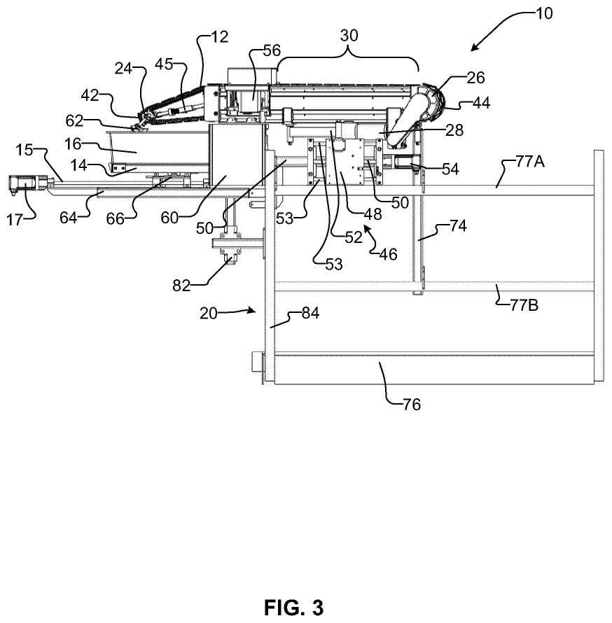

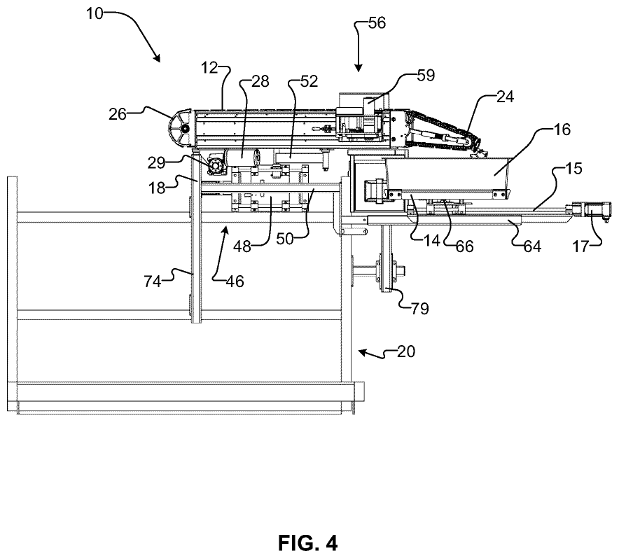

The swivelling movement of the conveyor is effected by means of a swivelling mechanism 46, as shown in FIGS. 3 and 4. This comprises a carriage 48 mounted for linear movement underneath the loading section 26 of the conveyor, and a swivel arm 52 having one end rotatably mounted on the carriage 48 and the other end attached to the lower side of the conveyor at about its midpoint. A stepper motor 54 mounted on the frame 18 is attached to a long screw 50 threaded into the carriage 48 to achieve linear motion of the carriage along guide members 53. This linear movement of the carriage 48 pushes or pulls the swivel arm 52 which, due to the fixed length of the swivel arm, causes the conveyor to be pushed away at an angle or pulled back. This swivels the conveyor 12 such that the unloading end 42 of the conveyor is moved into selected positions across the width W of the container 16.

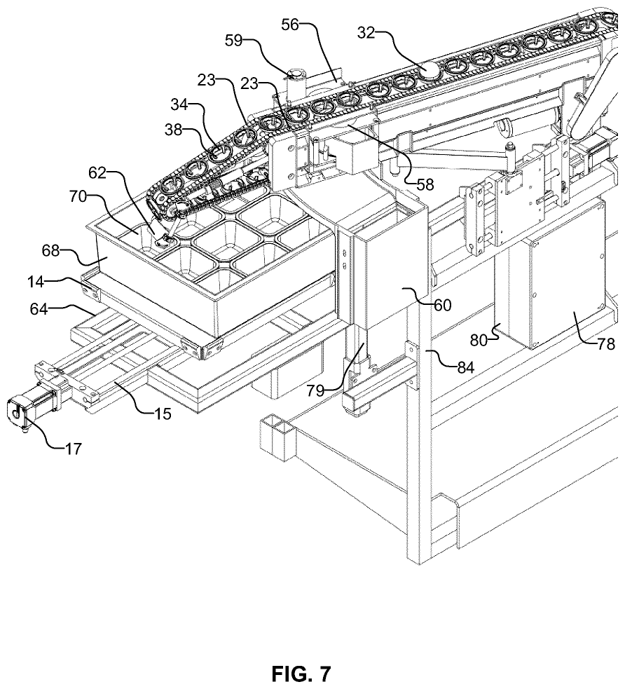

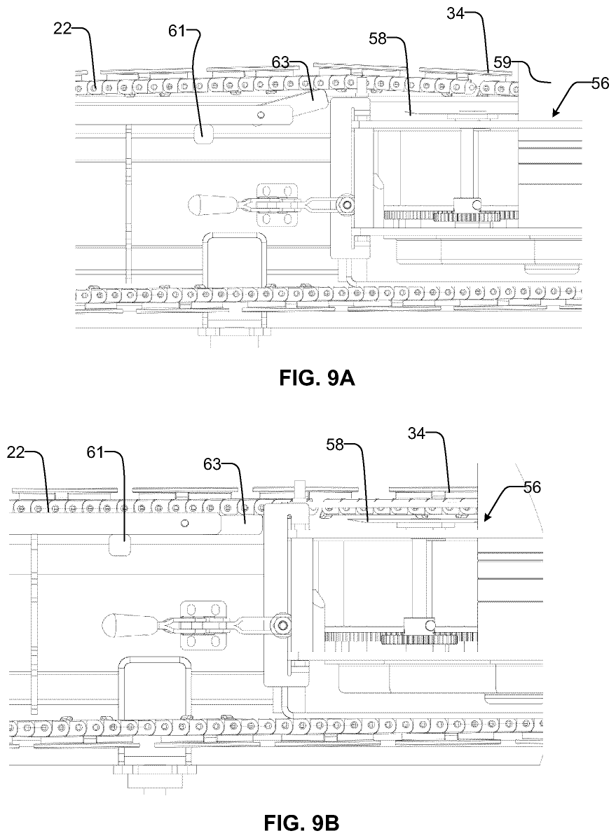

The mushroom packing apparatus 10 includes means for cutting the stems of the mushrooms in order to remove the compost that is attached to the mushrooms when they are picked out of the growing beds. Referring to FIGS. 7 and 9, the stem-cutting mechanism 56 has two rotary cutting blades 58 arranged underneath the upper section of the conveyor belt assembly to cut the stems 36 projecting downward through the holes 38 in the cups 34. The cutting blades are rotated on vertical axes by means of a motor 59. A discharge chute 60 is arranged to receive the cut-off stems and direct them to a waste bucket.

The stem cutting mechanism 56 in some embodiments includes means for positioning the cutting blades to cut each mushroom stem 36 at a selected target position for removal of compost. It is desirable to minimize the length that is cut off each stem and discarded, i.e., retaining as much of the stem as possible but with no compost. Referring to FIGS. 9A and 9B, this may be accomplished by means of a sensor 61 which detects the interface between the top of the compost and where the stem is clean, as the mushrooms approach the stem cutter on the conveyor, and a mechanism downstream of the sensor for raising or lowering the conveyor belt assembly 22 adjacent to the stem-cutting blades 58 so that the blades cut just above the interface. This mechanism comprises a lever arm 63 arranged to lift and lower the conveyor belt assembly. FIGS. 9A and 9B show the lever arm 63 in the raised and the lowered positions, respectively.

In some embodiments, the stem-cutting blades 58 may be raised and lowered to position them for cutting the stems, rather than raising and lowering the conveyor belt assembly. In other embodiments, the stem cutter comprises a single ultrasonic cutting blade.

The section of the conveyor 12 between the stem cutter 56 and the unloading end 42 is sloped downward in order that the vertical distance between the unloading end and the container 16 is minimized. This minimizes the distance the mushrooms fall when being packed. In some embodiments the conveyor 12 includes a deflector plate 62 arranged at the unloading end 42, as seen in FIG. 7. Mushrooms dropping off the conveyor are oriented by the deflector plate to land in the container 16 with their caps 40 upright. This is a desirable packing orientation for some consumers.

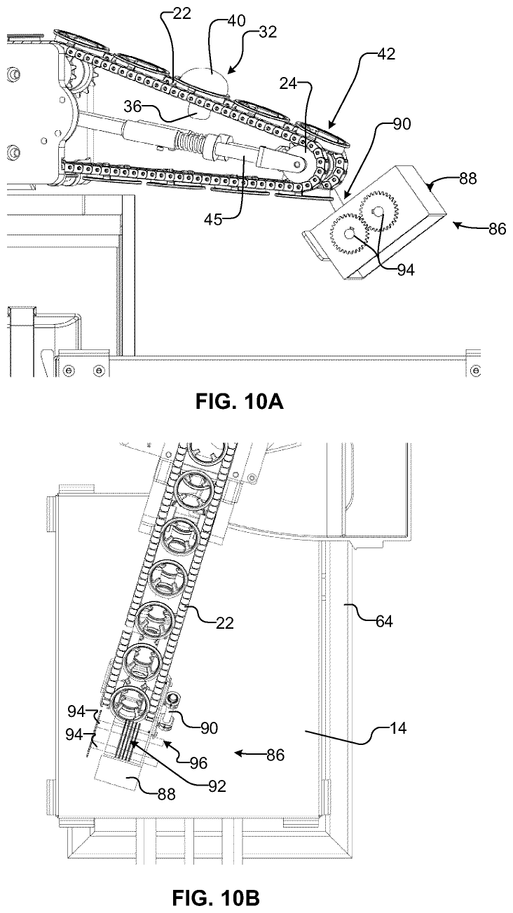

In some embodiments, the mushroom packing machine includes a mushroom slicer adjacent to the unloading end of the conveyor for cutting the mushrooms into slices prior to dropping them into the containers. As shown in FIGS. 10A and 10B, the slicer 86 comprises a slicer box 88, open at its top and bottom sides, mounted on the unloading end 42 of the conveyor by a mounting arm 90. The slicer box holds a set of spaced-apart slicing blades 92 arranged to be rotated on a pair of shafts 94 by a motor 96. The slicer box is arranged so that mushrooms are dropped into it from the unloading end 42 of the conveyor, are sliced by the blades 92, and the slices fall out of the open lower side of the box into a container.

The support platform 14 for holding the container 16 is moveably mounted on a support platform base 64. A threaded rod assembly 15 attached to the support platform base 64 and to the support platform 14 moves the support platform by means of a motor 17 arranged to rotate the threaded rod of the assembly 15. The support platform 14 is moveable horizontally, parallel to the longitudinal axis of the packing apparatus, both towards and away from the conveyor such that different locations along the length L and the container 16 can be brought into a position proximate to the unloading end 42 of the conveyor. Further, in some embodiments, by moving the support platform 14 towards the loading end 44 of the conveyor, the container 16 may be brought to a position close to the picking worker (who stands adjacent to the loading end of the conveyor) where it can be removed from the packing apparatus 10 when the container has been filled with mushrooms.

The support platform 14 includes a load cell 66, shown in FIGS. 3 and 4, operatively arranged to weigh the mushrooms loaded into the container.

In some embodiments, the support platform 14 can be set in different vertical positions, relative to the conveyor. This permits the mushroom packing apparatus 10 to accommodate containers having side walls of various heights, while minimizing the vertical distance between the unloading end of the conveyor and the bottom of the container, to minimize the distance the mushrooms fall. It also enables the support platform to be lowered so the high side wall of a container can pass under the unloading end of the conveyor and then to be raised again when the unloading end of the conveyor has passed over the side wall, thus minimizing the drop height while the container is being loaded. This raising and lowering may be programmed to occur automatically.

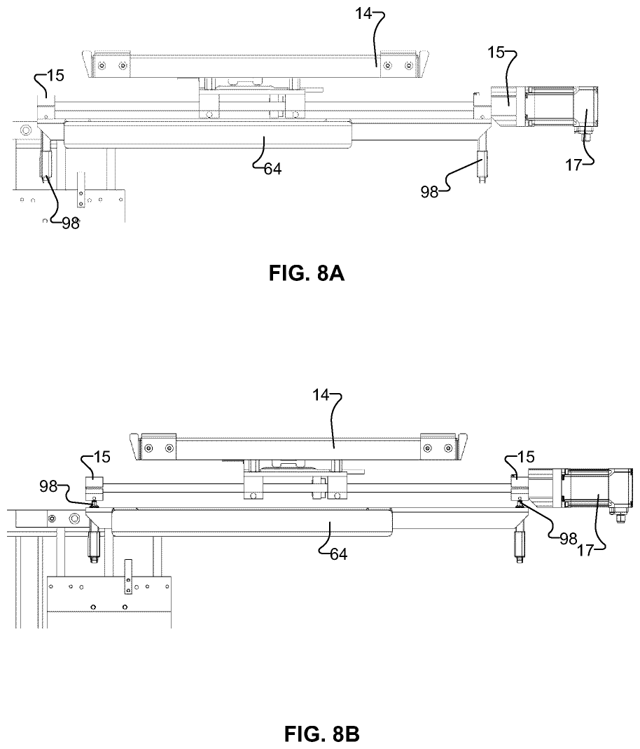

To accomplish this vertical movement of the support platform, as seen in FIGS. 8A and 8B a pair of actuators 98 affixed to the support platform base 64 is arranged to lift and lower the threaded rod assembly 15 and the support platform 14. When the actuators are extended, as shown in FIG. 8B, the support platform 14 (and thus the container 16 held on it) is raised. When the actuators are retracted, as shown in FIG. 8A, the support platform 14 is lowered.

The containers 16 that can be filled by means of the mushroom packing apparatus 10 may be of different types. One common practice in the mushroom growing industry is to pack mushrooms into consumer packages (tills) in which they are later sold in the grocery trade. These tills are open-topped boxes that usually hold 8 or 16 ounces of mushrooms. As explained above, for handling at the packing facility the tills are typically placed in containers commonly referred to as “lugs”. A lug holds a plurality of tills arranged in rows. For example, 12 tills arranged in three rows of four tills each is a conventional arrangement for 8 ounce tills. Nine tills arranged in three rows of three tills each is another conventional arrangement in the industry. In the present invention, the container 16 can take the form of a lug 68 holding a plurality of tills 70, and each till is to be filled with mushrooms to a desired weight, e.g., 8 ounces. By virtue of the movement of the unloading end 42 of the conveyor across the width of the lug, the unloading end 42 is brought into proximity with each of the rows, in order that the tills in each of the rows may be filled. By virtue of the horizontal movement of the support platform 14 toward and away from the conveyor 12, each of the tills in a row is brought into proximity with the unloading end 42 of the conveyor in order that all the tills in each row may be filled. When all the tills in the lug 68 are filled to the desired weight, the support platform 14 moves the lug horizontally towards the loading end 44 of the conveyor where the worker is standing and the conveyor is swivelled away from the worker so it is not an obstruction to lifting the filled lug off the support platform 14. The worker may then conveniently remove the filled lug and replace it with an empty one to be filled. Alternate positions for removal of the filled lug include extending the support platform 14 to other positions that would facilitate removal of the lug to the closest stacking position. The configuration will vary depending on harvest platform design.

It is also common practice in the industry for mushrooms to be packed into boxes, e.g., five pound boxes, and to be sold in that form. Here, the container 16 is a box having sidewalls and no internal divisions. The present invention is useful for packing such boxes. By virtue of the movement of the unloading end of the conveyor across the width W of the box 16, and the horizontal movement of the support platform 14 towards and away from the conveyor, mushrooms are placed into the box along its full width and length, resulting an evenly packed box.

The mushroom packing apparatus 10 may be mounted onto a conventional picking lorry 20 having a platform 76 on which a worker stands to pick mushrooms from a growing bed and load them into the cups on the conveyor. The loading may be done when the conveyor is moving or stationary. The speed of the conveyor may be adjusted to be relatively faster or slower in accordance with the skill of the worker.

It will be understood that the drawings show the portion of the picking lorry 20 to which the mushroom packing apparatus 10 attaches, but the picking lorry also includes a conventional base portion with wheels and a lifting mechanism (not shown). These enable the picking worker to move along the growing beds in a growing house with the packing apparatus and to reach beds at all heights.

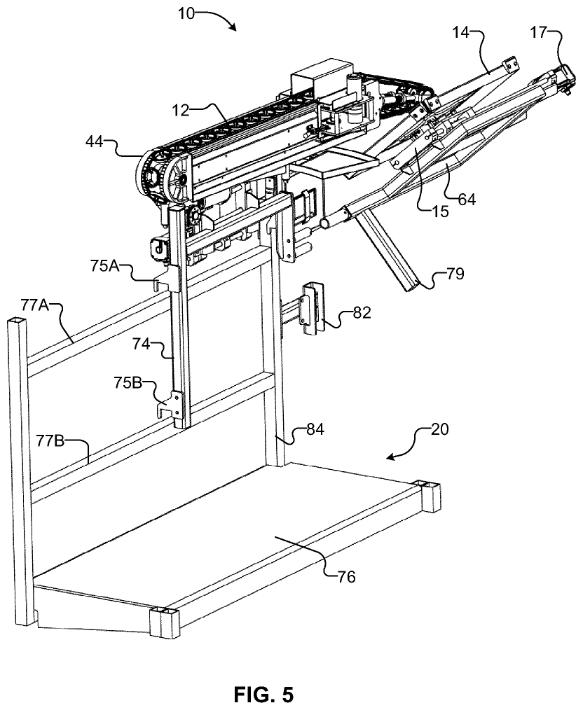

The means of attachment of the mushroom packing apparatus 10 onto the picking lorry depend upon the style of picking lorry, of which there are many in the industry. The drawings show an example of the means of attachment suitable for one such style of lorry. Referring to FIG. 5, in this example embodiment the mushroom packing apparatus has a vertical member 74 adjacent to the loading end 44 of the conveyor, with two hooks 75A, 75B which engage respective horizontal members 77A, 77B of the picking lorry. The support platform 14 and support platform base 64 is an assembly that pivotally attaches to the rest of the mushroom packing apparatus. It has a support member 79 extending downward from the support platform base 64 that engages with a channel member 82 on the picking lorry. One vertical end post 84 of the picking lorry also engages into a channel in the mushroom packing apparatus.

In some growing operations, instead of picking lorries, simple wheeled carts are used. The mushroom packing apparatus 10 may be readily attached to such wheeled carts.

The mushroom packing apparatus 10 is powered by one or more batteries 78 so the picking lorry 20 or wheeled cart may be moved along the length of the growing beds without requiring a wired connection to the growing facility.

The mushroom packing apparatus 10 includes a programmable logic controller (PLC) 80, programmed to operate the apparatus and connected to control the conveyor belt assembly, the conveyor swivelling, the movement of the support platform, the operation of the load cell, the stem cutter, the slicer and generally all moving parts of the packing apparatus.

In some embodiments, the PLC is programmed to move the conveyor around a till location until the till is at the target weight. Then the conveyor is paused automatically to ensure that another mushroom doesn't drop into that till. The support platform and/or the swivelling of the conveyor then relocates to position the unloading end 42 of the conveyor over the next till.

In some embodiments, controls for the packing apparatus may include an interface device, such as a smartphone app or tablet app, that allows configuration of the lug profiles and downloading of packing data. For example, picking supervisors may have the interface device and be able to connect to and configure one or more packing apparatuses. The packing apparatus may include a three-way toggle switch to allow choice of the lug profiles available to the picking worker. The interface device permits growing operation supervisors to program the configuration for each of the three profiles. For example, some interface devices will enable loading of 10 lb boxes, 5 lb boxes and 8 ounce tills. Other interface devices could load 5 lb boxes, 16 ounce tills and 24 ounce tills. The picking worker choses the profile for the type of till and lug combination to be packed. As an example, the supervisor may use the interface device to configure toggle position A to be 8 ounce tills, position B to be 5 lb boxes and position C to be 10 lb boxes. The picking worker would then move the three-way toggle switch to the appropriate position for the container being loaded.

This interface device will also upload all data that has been recorded by the PLC since the last upload. The PLC may log the production data and alarm data for subsequent upload to the interface device and then to data storage such as cloud storage. Production data is important in the mushroom growing industry as workers are typically paid by the weight picked, not hourly. The ability to electronically and automatically record production for each interface device, and therefore each worker, also enables automated payroll calculation.

The mushroom packing apparatus 10 operates according to the following method. The conveyor, support platform and load cell are actuated, under the control of the PLC. Mushrooms are manually loaded onto the conveyor and the conveyor moves them to the stem cutter where their stems are cut to remove compost. The conveyor moves the trimmed mushrooms to the unloading end and drops them into the tills in the lug. During unloading, the conveyor swivels to move the unloading end into proximity with each row of tills in the lug, and the support platform moves back and forth horizontally to move the tills in each row into proximity with the unloading end, all under the control of the PLC, to fill each till with mushrooms to the desired weight, e.g., 8 ounces. In some embodiments, the conveyor is paused automatically after loading each till to ensure that another mushroom doesn't drop into it, and the support platform and/or the swivelling of the conveyor then relocates to position the unloading end 42 of the conveyor over the next till. When all the tills in the lug are filled to the desired weight, the support platform 14 moves the lug horizontally towards the loading end of the conveyor where the worker is standing and the conveyor is swivelled away from the worker so it is not an obstruction to lifting the filled lug off the support platform. The worker may then conveniently remove the filled lug and replace it with an empty one to be filled. Alternate positions for removal of the filled lug include extending the support platform 14 to other positions that would facilitate removal of the lug to the closest stacking position. The worker does not need to manually handle individual tills. Essentially the same method is carried out where the container is a box rather than a lug with tills, except that the filling of mushrooms into the box is done at various locations within the box rather than into individual tills.

### Example

A mushroom packing apparatus in accordance with the invention was mounted on a wheeled cart and operated. It had a conveyor 12 that is 1215 mm long and a belt assembly 22 that is 88 mm wide. The support platform (to the end of the motor 17) extends 601 mm beyond the unloading end 42 of the conveyor 12. The support platform extends beyond the end of the wheeled cart to maximize room for the worker on the cart. The conveyor moved at a speed of 10.4 m/min. The picking worker achieved a rate of 140 lbs per hour after using the apparatus for only 20 minutes. For comparison, a typical industry picking rate for manual picking is between 35 and 65 pounds per hour. The conveyor speed was not adjusted to optimize the rate for the worker picking the mushrooms in this test. During the test, the conveyor paused when moving from one till to the other in the container. The conveyor speed and the pauses for swivel and support platform movements may be adjusted, resulting in an increased picking rate.

Throughout the foregoing description and the drawings, in which corresponding and like parts are identified by the same reference characters, specific details have been set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As will be apparent to those skilled in the art in the light of the foregoing disclosure, many alterations and modifications are possible in the practice of this invention without departing from the scope thereof. As one example, the conveyor belt assembly may be configured in various ways to avoid the transfer of compost into the containers, as the picking worker is inserting the mushrooms into the loading end of the conveyor. Alternate structures include a mesh or net that allows the compost to fall through and not be transported to the container. Accordingly, the scope of the invention is to be construed in accordance with the following claims.

What is claimed is:

1. A mushroom packing apparatus, comprising:
(a) a conveyor having a mushroom loading section for receiving mushrooms onto the conveyor and an unloading end for unloading the mushrooms from the conveyor;
(b) a movable support platform adjacent to the unloading end of the conveyor for supporting a container holding a plurality of mushroom tills, the tills being arranged in a plurality of rows with each said row extending along a length of the container and having a plurality of the tills;
(c) the movable support platform having weighing means for determining the weight of the mushrooms loaded into each of the tills in the container;
(d) the unloading end of the conveyor being movable between positions proximate to each of the rows of tills in the container, for unloading of the mushrooms into the tills in each of the rows;
(e) the movable support platform being movable such that each of the tills in a respective one of said rows in the container is moved into a position proximate to the unloading end of the conveyor, for unloading of the mushrooms into each of the tills within said respective row;
(f) means for cutting stems from the mushrooms being conveyed on the conveyor; and
(g) control means for controlling operation of the apparatus.

2. An apparatus according to claim 1, wherein the movable support platform is further movable such that the container is moved from a first position for receiving the mushrooms from the unloading end of the conveyor into the tills to a second position for removal of the container of tills loaded with mushrooms from the support platform.

3. A mushroom packing apparatus, comprising:
(a) a conveyor having a mushroom loading section for receiving mushrooms onto the conveyor and an unloading end for unloading the mushrooms from the conveyor;
(b) a movable support platform adjacent to the unloading end of the conveyor for supporting a container, the container having a length generally parallel to a longitudinal axis of the packing apparatus and a width perpendicular to said length;
(c) the movable support platform having weighing means for determining the weight of the mushrooms loaded into the container;
(d) the unloading end of the conveyor being movable into a plurality of positions proximate to respective locations across the width of the container, for unloading the mushrooms into said locations across the width of the container;
(e) the movable support platform being movable such that a plurality of locations along the length of the container are moved into a position proximate to the unloading end of the conveyor, for unloading the mushrooms into the container at said plurality of locations along its length;
(f) means for cutting stems from the mushrooms being conveyed on the conveyor; and
(g) control means for controlling operation of the apparatus.

4. An apparatus according to claim 3, wherein the movable support platform is further movable such that the container is moved from a first position for receiving the mushrooms from the unloading end of the conveyor to a second position for removal of the container loaded with mushrooms from the support platform.

5. An apparatus according to claim 1, wherein the control means is arranged to control movement of the conveyor, of the unloading end of the conveyor, of the movable support platform and of the stem cutter.

6. An apparatus according to claim 1, further comprising means for moving the support platform vertically relative to the conveyor.

7. An apparatus according to claim 1, further comprising means for determining a target cutting position on the stem of each said mushroom on the conveyor and for bringing the mushrooms into a position for cutting of the stem of each mushroom at the respective target cutting position.

8. An apparatus according to claim 1, further comprising means for attaching the mushroom packing apparatus to a mushroom picking lorry or wheeled cart.

9. An apparatus according to claim 1, wherein the conveyor comprises a conveyor belt assembly having mushroom-holding means for holding mushrooms loaded onto the conveyor.

10. An apparatus according to claim 9, wherein the mushroom-holding means comprises cups.

11. An apparatus according to claim 1, wherein the movable support platform is movable horizontally in both directions parallel to the length of the container.

12. An apparatus according to claim 1, further comprising a mushroom slicer adjacent to the unloading end of the conveyor for slicing the mushrooms into a plurality of slices.

13. An apparatus according to claim 1, further comprising a deflector adjacent the unloading end of the conveyor arranged to orient each mushroom to drop in a selected orientation.

14. A mushroom packing apparatus, comprising:
(a) a conveyor having a mushroom loading section for receiving mushrooms onto the conveyor and an unloading end for unloading the mushrooms from the conveyor into a container;
(b) a movable support platform adjacent to the unloading end of the conveyor for supporting the container;
(c) the movable support platform having weighing means for determining the weight of the mushrooms loaded into the container;
(d) the unloading end of the conveyor being movable into a plurality of positions relative to the container, for unloading the mushrooms into a plurality of locations in the container;
(e) the movable support platform being movable such that a plurality of locations in the container are movable into a position proximate to the unloading end of the conveyor, for unloading the mushrooms into the plurality of locations in the container; and
(f) control means for controlling operation of the apparatus.

15. An apparatus according to claim 14, further comprising means for cutting stems from the mushrooms being conveyed on the conveyor.

16. An apparatus according to claim 14, wherein the movable support platform is further movable such that the container is moved from a first position for receiving the mushrooms from the unloading end of the conveyor to a second position for removal of the container loaded with mushrooms from the support platform.

17. An apparatus according to claim 14, wherein the control means is arranged to control movement of the conveyor, of the unloading end of the conveyor, and of the movable support platform.

18. An apparatus according to claim 14, further comprising means for moving the support platform vertically relative to the conveyor.

19. An apparatus according to claim 15, further comprising means for determining a target cutting position on the stem of each said mushroom on the conveyor and for bringing the mushrooms into a position for cutting of the stem of each mushroom at the respective target cutting position.

20. An apparatus according to claim 14, further comprising means for attaching the mushroom packing apparatus to a mushroom picking lorry or wheeled cart.

21. An apparatus according to claim 14, wherein the conveyor comprises a conveyor belt assembly having cups for holding mushrooms loaded onto the conveyor.

22. An apparatus according to claim 14, wherein the movable support platform is movable horizontally in both directions parallel to the length of the container.

23. A method of packing mushrooms into a plurality of tills held in a container, comprising the steps of:
(a) placing the mushrooms onto a loading section of a conveyor;
(b) cutting the stems of the mushrooms on the conveyor;
(c) moving the mushrooms on the conveyor to an unloading end of the conveyor;
(d) dropping the mushrooms from the unloading end of the conveyor into the tills, the tills being arranged in a plurality of rows across the width of the container, with each row having a plurality of tills along the length of the container, the container being supported on a movable support platform;
(e) moving the unloading end of the conveyor into positions proximate to each of the rows of tills in the container, for unloading of the mushrooms into the tills in each of the rows; and
(f) moving the support platform to move each of the tills in each row into a position proximate to the unloading end of the conveyor, for unloading of the mushrooms into each of the tills in the respective row.

24. A method according to claim 23, further comprising, after step (f):
(g) moving the support platform to move the container from a loading position to a removal position for removal of the container from the support platform.

25. A method of packing mushrooms into a container, comprising the steps of:
(a) placing the mushrooms onto a loading section of a conveyor;
(b) cutting the stems of the mushrooms on the conveyor;
(c) moving the mushrooms on the conveyor to an unloading end of the conveyor;
(d) dropping the mushrooms from the unloading end of the conveyor into the container, the container having a length generally parallel to a longitudinal axis of the packing apparatus and a width perpendicular to said length, the container being supported on a movable support platform;
(e) moving the unloading end of the conveyor into positions proximate to a plurality of positions proximate to respective locations across the width of the container, for unloading of the mushrooms into the container at said plurality of locations; and
(f) moving the support platform to move the container such that locations along the length of the container are brought into a position proximate to the unloading end of the conveyor, for unloading of the mushrooms into the container at said locations along the length of the container.

26. A method according to claim 25, further comprising, after step (f):
(g) moving the support platform to move the container from a loading position to a removal position for removal of the container from the support platform.
